(19) United States
(12) Patent Application Publication
(10) Pub. No.: US 2013/0185486 A1
(43) Pub. Date: Jul. 18, 2013

(54) STORAGE DEVICE, STORAGE SYSTEM, AND INPUT/OUTPUT CONTROL METHOD PERFORMED IN STORAGE DEVICE

(71) Applicant: Samsung Electronics Co., Ltd., Suwon-Si (KR)

(72) Inventors: Myung-hyun JO, Hwaseong-si (KR); Seong-nam KWON, Bucheon-si (KR)

(73) Assignee: Samsung Electronics Co., Ltd., Suwon-Si (KR)

(21) Appl. No.: 13/742,571

(22) Filed: Jan. 16, 2013

(30) Foreign Application Priority Data
Jan. 18, 2012 (KR) 10-2012-0005838

(51) Int. Cl. G06F 12/02

(52) U.S. Cl. CPC G06F 12/0246
USPC 711/103; 711/147

(57) ABSTRACT

A storage device includes a storage unit including a plurality of regions in which data is stored, the storage unit configured to input and output the data through channels and ways corresponding to the plurality of regions; an interface unit including a multi-entry queue, the multi-entry queue including a plurality of entries in which received commands are entered, the interface unit being configured to transmit data to be written in and read from the storage unit in response to the commands entered in the plurality of entries of the multi-entry queue; and a firmware unit configured to allocate the plurality of entries of the multi-entry queue corresponding to the commands received by the interface unit.

### CROSS-REFERENCE TO RELATED APPLICATIONS

This application claims priority under 35 U.S.C. §119 to Korean Patent Application No. 10-2012-0005838, filed on Jan. 18, 2012, in the Korean Intellectual Property Office, the disclosure of which is incorporated herein in its entirety by reference.

### BACKGROUND

Example embodiments relate to a storage device, a storage system, and an input/output control method performed in the storage device, and more particularly, to a storage device, a storage system, and an input/output control method performed in the storage device capable of efficiently controlling an input/output bottleneck section.

Firmware of a storage device controls data input/output. Thus, the data input/output is performed in synchronization with an operation of firmware. Accordingly, a bottleneck phenomenon may occur in the data input/output in the storage device.

### SUMMARY

Example embodiments provide a storage device, a storage system, and an input/output control method performed in the storage device capable of efficiently controlling an input/output bottleneck section.

According to at least one example embodiment, a storage unit may include a plurality of regions in which data is stored, the storage unit configured to input and output the data through channels corresponding to the plurality of regions; an interface unit including a multi-entry queue, the multi-entry queue including a plurality of entries in which received commands are entered, the interface unit being configured to transmit data to be written in and read from the storage unit in response to the commands entered in the plurality of entries of the multi-entry queue; and a firmware unit configured to allocate the plurality of entries of the multi-entry queue corresponding to the commands received by the interface unit.

According to at least one example embodiment, a storage device may include a data storage unit including a plurality of logical pages arranged in a matrix, the matrix having a plurality of channels; and an interface unit configured to receive commands for accessing the plurality of logical pages and to control access to the plurality of logical pages based on the received commands, the interface unit including a queue having a plurality of entries that correspond to the plurality of channels, respectively, each of the plurality of entries holding one or more commands from among the received commands, the one or more commands held by each entry being commands for the channel corresponding to the entry.

According to at least one example embodiment, there is provided a storage device including: a storage unit including a plurality of regions in which data is stored and for inputting and outputting the data through channels and ways corresponding to the plurality of regions; an interface unit including a multi-entry queue including a plurality of entries in which received commands are entered, and for transmitting data to be written in and read from the storage unit in response to the commands entered in the plurality of entries of the multi-entry queue; and a firmware unit for allocating the plurality of entries of the multi-entry queue corresponding to the commands received by the interface unit.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a block diagram of a storage device according to at least one example embodiment;

FIG. 2 is a diagram for explaining channels and ways of a storage unit of FIG. 1;

FIG. 3 illustrates a multi-entry queue included in an interface unit FIG. 1;

FIGS. 4 through 6 are flowcharts illustrating an input/output control method performed in the storage device of FIG. 1, according to at least one example embodiment;

FIGS. 7 and 8 are diagrams for explaining an in-order input/output method and an out-order input/output method, respectively;

FIG. 9 is a block diagram of a storage system, according to at least one example embodiment;

FIG. 10 is a block diagram of a computer system according to at least one example embodiment; and

FIG. 11 is a block diagram of a server system and a network system according to at least one example embodiment.

### DETAILED DESCRIPTION OF THE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the tennis first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

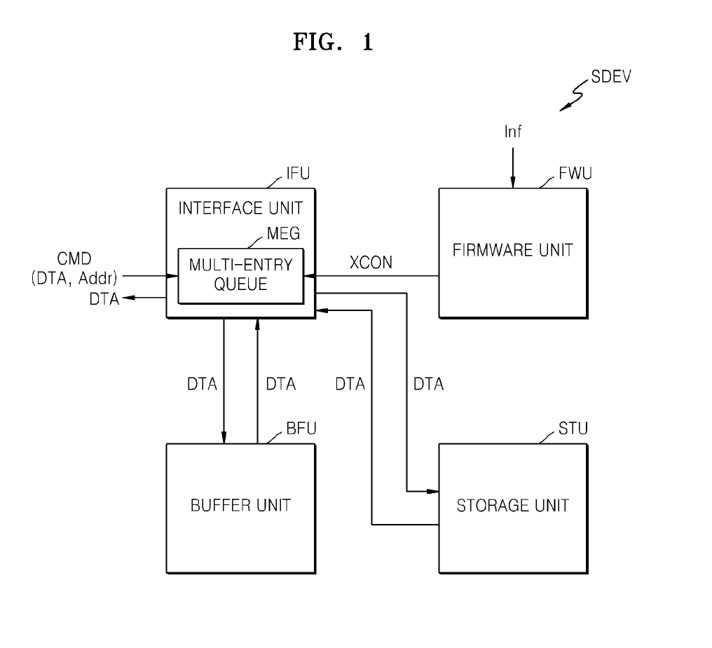

FIG. 1 is a block diagram of a storage device SDEV according to at least one example embodiment.

Referring to FIG. 1, the storage device SDEV includes a storage unit STU, a firmware unit FWU, an interface unit IFU, and a buffer unit BFU. The storage unit STU stores data DTA therein. The storage unit STU may be a hard disk or a nonvolatile memory such as a flash memory. However, example embodiments are not limited thereto.

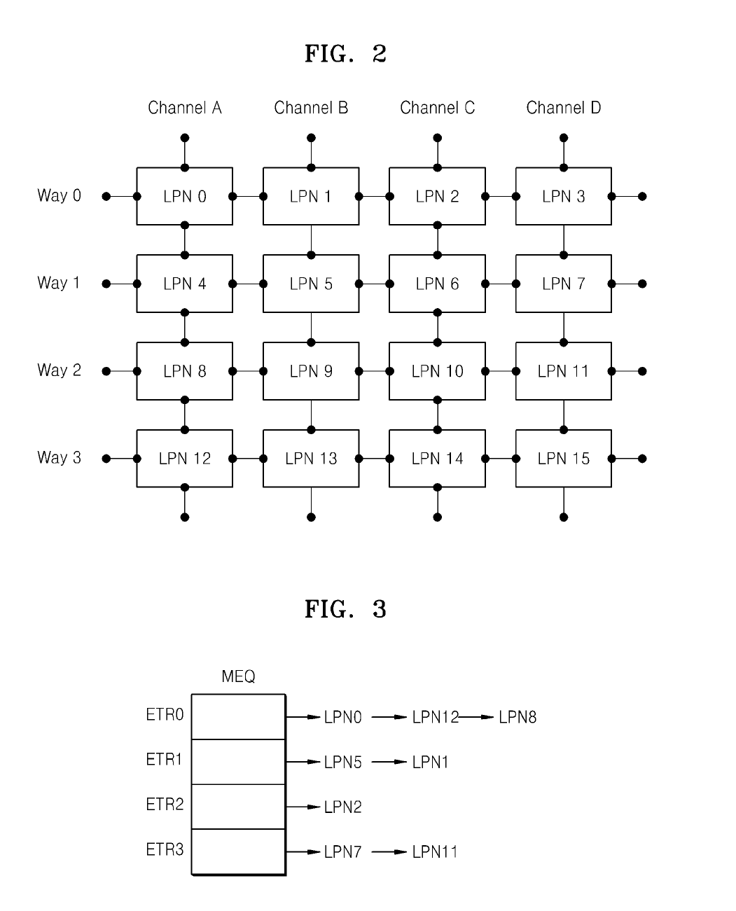

If the storage unit STU is the flash memory, as shown in FIG. 2, data input/output into/from the storage unit STU are performed based on channels and ways corresponding to regions of the flash memory. FIG. 2 illustrates a four-channel and 4-way flash memory. The number of channels and ways may be set corresponding to input/output bandwidths and capacity of the flash memory. For example, a 128 GB flash memory may be set having 8 channels and 4 ways, and a 256 GB flash memory may be set having 8 channels and 8 ways.

Data input/output may be simultaneously performed on regions of the storage unit STU according to the present embodiment through channels and ways. In this regard, each region may be divided into logical page numbers (LPNs). For example, data input/output are simultaneously performed on LPN0 through A/0 (channel/way) and on LPN5 through B/1 (channel/way).

A flash translation layer (FTL) included in the firmware unit FWU that will be described later performs mapping on an address Addr of a command CMD received by the interface unit IFU to an LPN. In this regard, the FTL may perform mapping in consideration of endurance of each region. For example, if LPN1 has a great number of programs/erasures, the FTL may perform mapping on the address Addr of the command CMD to a region having a small number of programs/erasures other than LPN1

Referring back to FIG. 1, the interface unit IFU provides an interface used to receive or transmit a write command for storing the data DTA in the storage unit STU or a read command for reading the data DTA stored in the storage unit STU from or to an external device such as a host device (not shown). For example, the interface unit IFU may provide a serial advanced technology attachment (SATA) interface or a serial attached SCSI (SAS) protocol interface.

The interface unit IFU according to the present embodiment includes, in particular, a multi-entry queue MEQ. The multi-entry queue MEQ includes entries ETR0˜ETR3 in which commands received by the interface unit IFU are entered. The entries ETR0˜ETR3 of the multi-entry queue MEQ according to the present embodiment may respectively correspond to the 4 channels of FIG. 2.

For example, as shown in FIG. 3, the multi-entry queue MEQ included in the interface unit IFU according to the present embodiment may include the ETR0˜ETR3 respectively corresponding to the 4 channels of FIG. 2. For example, a command for a channel A may be entered in the entry ETR0, and a command for a channel B may be entered in the entry ETR1. Likewise, a command for a channel C may be entered in the entry ETR2, and a command for a channel D may be entered in the entry ETR3.

Referring to FIG. 3, a command for LPN0 on which input/output are performed through the channel A of FIG. 2 may be entered in the entry ETR0 of the multi-entry queue MEQ, and a command for LPN5 on which input/output are performed through the channel B of FIG. 2 may be entered in the entry ETR1 of the multi-entry queue MEQ. Thereafter, if a command for LPN 12 on which input/output are performed through the channel A is received, the command may be linked to LPN0 that is first entered in the entry ETR0 of the multi-entry queue MEQ, and thus the command for LPN12 may be entered in the entry ETR0 of the multi-entry queue MEQ. This applies to the entries ETR2 and ETR3 of the multi-entry queue MEQ, and LPNs entered in the entries ETR2 and ETR3, and thus detailed descriptions thereof will be omitted here.

Referring back to FIG. 1, as described above, LPNs corresponding to commands may be set by the firmware unit FWU. Thus, the firmware unit FWU determines the entries ETR0˜ETR3 of the multi-entry queue MEQ included in the interface unit IFU in which the commands CMD are to be entered. That is, the firmware unit FWU performs resource allocation or release on the interface unit IFU.

The firmware unit FWU may perform the above-described mapping in response to information inf regarding the commands CMD received by the storage device SDEV. The firmware unit FWU may generate a control signal XCON used to determine the entries ETR0˜ETR3 of the multi-entry queue MEQ included in the interface unit IFU to which the commands CMD are to be allocated. The firmware unit FWU may be included in a static random access memory (SRAM).

The interface unit IFU transmits the data DTA regarding the commands CMD entered in the entries ETR0˜ETR3 determined by the firmware unit FWU according to the control signal XCON. The data DTA may be data written in or read from the storage unit STU. However, the buffer unit BFU may be used to transmit and receive the data DTA between the interface unit IFU and the storage unit STU. More specifically, data received from an external device may be temporarily buffered by the buffer unit BFU and transmitted to the storage unit STU. Likewise, data received from the storage unit STU may be temporarily buffered by the buffer unit BFU and transmitted to the interface unit IFU.

If the data DTA temporarily stored in the buffer unit BFU is transmitted to the storage unit STU or is output to the outside through the interface unit IFU, the corresponding entry of the multi-entry queue MEQ of the interface unit IFU may be released by the firmware unit FWU. The buffer unit BFU may be implemented as a dynamic RAM (DRAM).

As described above, the firmware unit FWU of the storage device SDEV according to the present embodiment performs resource allocation or release so as to transmit and receive data within the storage device SDEV. The interface unit IFU of the storage device SDEV according to the present embodiment transmits data corresponding to allocated entries. Thus, the storage device SDEV according to the present embodiment does not need to hold data transmission and reception in order to receive resources that occur as the firmware unit FWU controls a data flow.

An input/output control method performed in a storage device according to at least one example embodiment will now be described in more detail and the advantages of efficiently performing an input/output control of the storage device in accordance with at least one example embodiment will now also be described below.

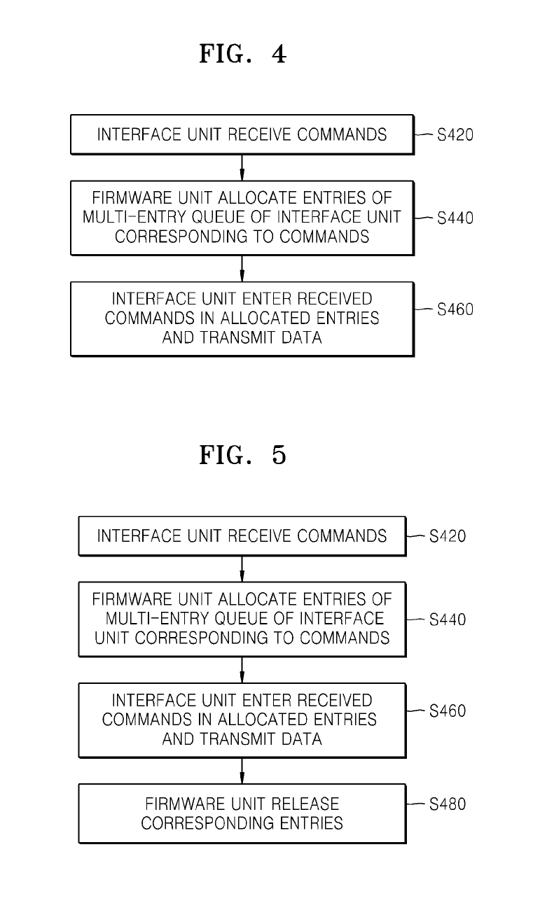

FIGS. 4 through 6 are flowcharts illustrating an input/output control method performed in the storage device SDEV of FIG. 1, according to at least one example embodiment.

Referring to FIGS. 1 and 4, according to the input/output control method performed in the storage device SDEV of the present embodiment, if the interface unit IFU receives the commands CMD (operation S420), the firmware unit FWU allocates entries of the multi-entry queue MEQ of the interface unit IFU corresponding the commands CMD (operation S440). The interface unit IFU enters the received commands CMD in the allocated entries, and transmits the data DTA corresponding to the commands CMD (operation S460). As described above, the interface unit IFU may transmit the data DTA to the buffer unit BFU or output the data DTA stored in the buffer unit BFU to the outside.

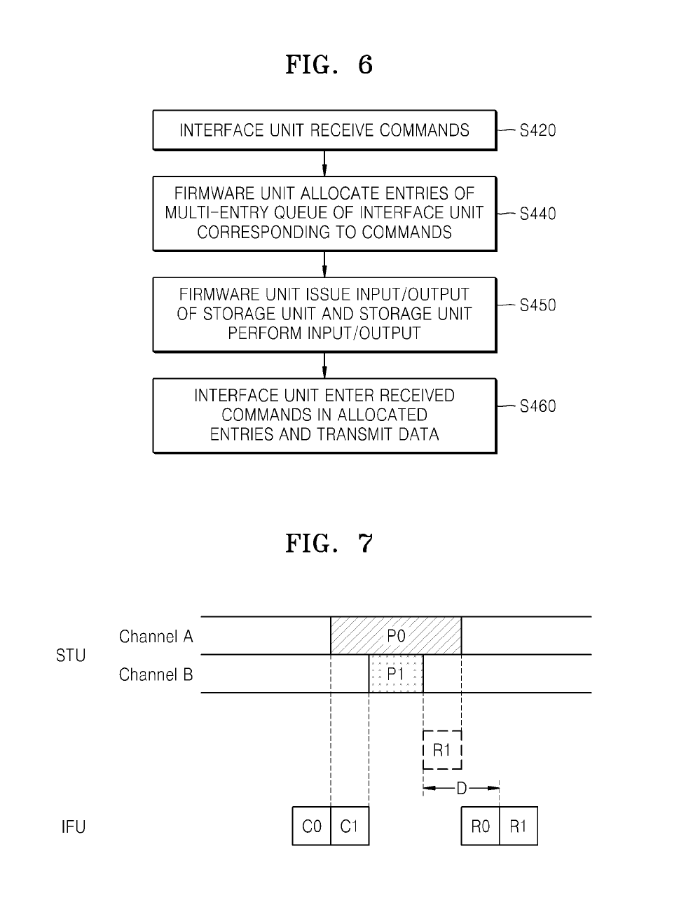

The input/output control method performed in the storage device SDEV of the present embodiment may further include an operation 5480 of releasing the entries of the multi-entry queue MEQ of the interface unit IFU that have completely finished processing on the commands CMD as shown in FIG. 5. If the interface unit IFU receives the command CMD to read the data DTA stored in the storage unit STU, as shown in FIG. 6, the input/output control method performed in the storage device SDEV of the present embodiment may further include an operation 5450 of issuing input/output of the storage unit STU after or simultaneously the firmware unit FWU allocates the entries of the multi-entry queue MEQ of the interface unit IFU corresponding to the commands CMD (operation 5440) as shown in FIG. 6. If the input/output of the storage unit STU are issued, the storage unit SU may perform the input/output (operation S450).

Referring back to FIG. 1, input/output performance of the storage unit STU may differ according to how to write and read data and how many times data is written and read. Alternatively, a bottleneck phenomenon may take place if two or more commands are accessed to the same channel or way (data input/output are requested). Alternatively, time taken to process commands may differ according to types of commands. Therefore, a response to a later requested command may precede a response to an earlier requested command.

FIGS. 7 and 8 are diagrams for explaining an in-order input/output method and an out-order input/output method, respectively.

Referring to FIGS. 1, 7, and 8, for example, the interface unit IFU sequentially receives commands C0 and C1. In this regard, data regarding the command C0 may be transmitted to and received from a corresponding region of the storage unit STU through the channel A, and data regarding the command C1 may be transmitted to and received from a corresponding region of the storage unit STU through the channel B. As described above, processing P1 performed on the command C1 may conclude before processing P0 performed on the command C0 does. Thus, a response R1 to the command C1 may precede a response R0 to the command C0. In this regard, the response R0 or R1 may be data of which reading is requested or a processing result of a write request.

In this way, when a sequence of commands received by the interface unit IFU and a sequence of responses processed by the storage unit STU are switched, the in-order input/output method shown in FIG. 7 or the out-order input/output method shown in FIG. 8 may be applied.

The in-order input/output method sets the sequence of responses based on the sequence of received commands irrespective of a sequence of processing commands. Referring to FIG. 7, although the response R1 to the command C1 precedes (a square in a dotted line) the response R0 to the command C0, the interface unit IFU processes the response R0 earlier than the response R1. However, the in-order input/output method may cause a delay D until the interface unit IFU receives the response R1 after the processing P1 is performed.

Meanwhile, the out-order input/output method sets the sequence of responses based on the sequence of processing commands irrespective of the sequence of received commands. Referring to FIG. 8, if the processing P1 is completely performed on the command C1 earlier than the processing P0 is completely performed on the command C0, the response R1 to the command C1 precedes the response R0 to the command C0 and is transmitted to the interface unit IFU.

The out-order input/output method may prevent the delay D caused by the in-order input/output method that processes a response to an earlier processed command later than a response to an earlier received command. Nevertheless, the out-order input/output method may also cause the delay D since all processes performed by the storage unit STRU must be periodically checked for reordering of a response as shown in FIG. 8. The delay D of FIG. 8 cannot be ignored since integration or capacity of the storage unit STU is increasing.

However, according to the storage device SDEV and the input/output control method performed in the storage device SDEV according to at least one example embodiment, the firmware unit FWU and the interface unit IFU divide input/output processing in parallel so that the firmware unit FWU allocates and releases hardware resources, and the interface unit IFU transmits allocated resources. Therefore, according to the storage device SDEV and the input/output control method performed in the storage device SDEV according to at least one example embodiment, the out-order input/output method may not generate a holding section (a delay) for controlling input/output since the firmware unit FWU is synchronized with hardware as shown in FIG. 8. That is, optimal control of data transmission (input/output) may be set without a reordering overhead.

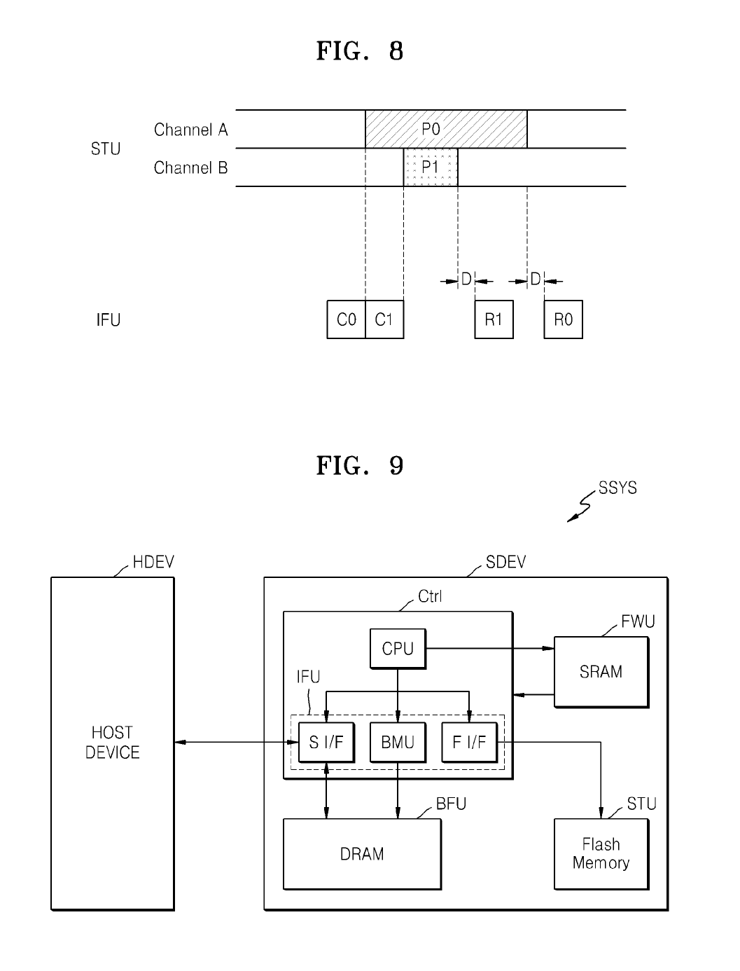

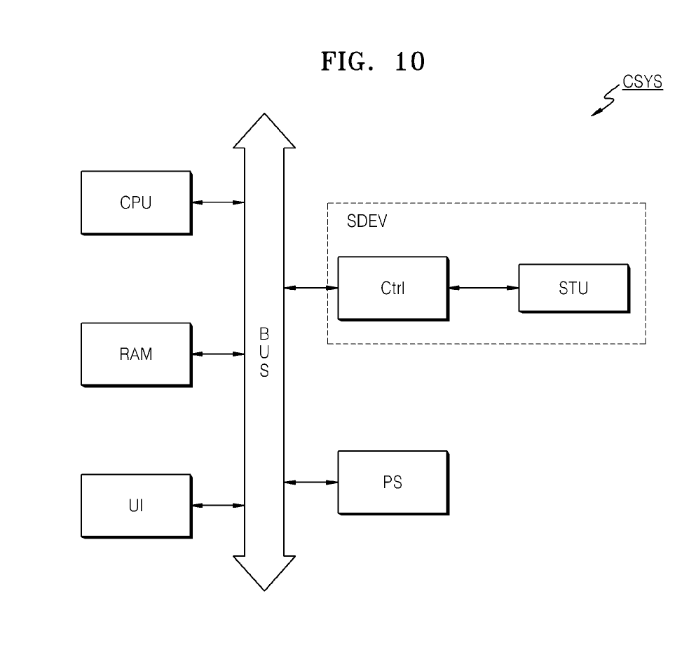

FIG. 9 is a block diagram of a storage system SSYS, according to at least one example embodiment.

Referring to FIG. 9, the storage system SSYS according to the present embodiment includes a host device HDEV and the storage device SDEV. The host device HDEV transmits a command to the storage device SDEV. The storage device SDEV transmits a response to the command to the host device HDEV.

As shown in FIG. 1, the storage device SDEV includes the interface unit IFU, the firmware unit FWU, the buffer unit BFU, and the storage unit STU. If the storage unit STU is a flash memory, the firmware unit FWU may be included in a SDRAM, and the buffer unit BFU may be implemented as a DRAM. As described above, the interface unit IFU may provide an SATA or SAS protocol interface. However, example embodiments are not limited thereto. In addition to the STA or SAS protocol interface, the interface unit IFU may provide various protocol interfaces such as USB (Universal Serial Bus), MMC (Man Machine Communication), PCI-E (Peripheral Component Interconnect-Express), PATA (Parallel Advanced Technology Attachment), SCSI (Small Computer System Interface), ESDI (Enhanced Small Device Interface), IDE (Intelligent Drive Electronics), and the like with the host device HDEV. According to at least one example embodiment, if the storage unit STU is the flash memory, the storage device SDEV of FIG. 1 or 9 may be, for example, a solid state drive (SSD).

Furthermore, the storage device SDEV may further include a controller Ctrl. In this regard, the interface unit IFU may be included in the controller Ctrl. The controller Ctrl may further include a buffer management unit BMU for managing the buffer unit BFU and a flash interface unit F I/F for providing an interface with the flash memory, in addition to the interface unit IFU. The controller Ctrl may further include a CPU for providing commands regarding operations of the elements of the storage device SDEV. The information Inf of FIG. 1 received by the firmware unit FWU may be generated by the CPU of the controller Ctrl of FIG. 9. The firmware unit FWU, along with the interface unit IFU, may control resource allocation in the buffer management unit BMU and the flash interface unit F I/F.

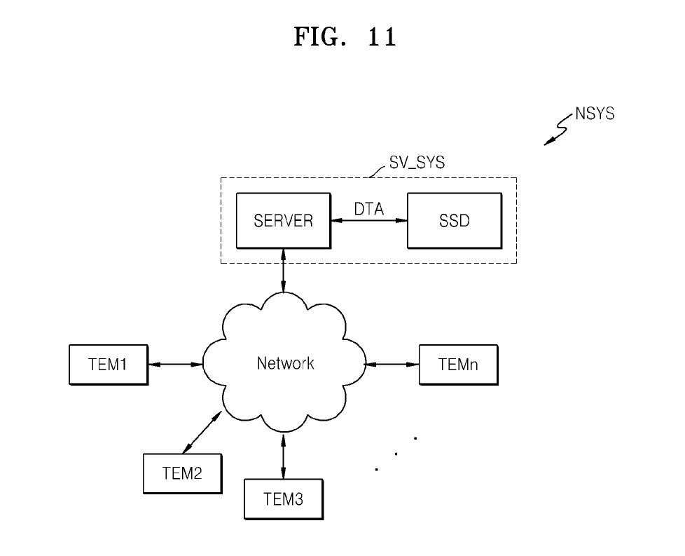

FIG. 10 is a block diagram of a computer system CSYS according to at least one example embodiment.

Referring to FIG. 10, the computer system CSYS according to the present embodiment includes the CPU electrically connected to a bus BUS, a user interface UI, and the storage device SDEV. The storage device SDEV includes the controller Ctrl of FIG. 9 and the storage unit STU. Although not shown, the storage device SDEV may further include an SRAM and a DRAM described with reference to FIG. 9. For example, according to at least one example embodiment, the storage device SDEV of FIG. 10 may have the same structure and operation as that described above with reference to the storage device SDEV of FIG. 9. Thus, the computer system CSYS according to the present embodiment controls optimal data input/output of the storage device SDEV, thereby enhancing performance of the computer system CSYS.

The computer system CSYS according to the present embodiment may further include a power supply device PS. The computer system CSYS according to the present embodiment may further include a nonvolatile memory device (for example, an RAM) for transmitting and receiving data between the CPU and the storage device SDEV.

If the computer system CSYS according to the present embodiment is a mobile device, the computer system CSYS may additionally include a battery for supplying an operating voltage of the computer system CSYS and a modem such as a baseband chipset. It would have been obvious to one of ordinary skill in the art that the computer system CSYS according to the present embodiment may further include an application chipset, a camera image processor (CIP), a mobile DRAM, and the like, and thus detailed descriptions thereof will not be provided here.

FIG. 11 is a block diagram of a server system SV_SYS and a network system NSYS according to at least one example embodiment.

Referring to FIG. 11, the network system NSYS according to the present embodiment may include the server system SV_SYS and a plurality of terminals TEM1˜TEMn connected over a network. The server system SV_SYS according to the present embodiment may include a server SERVER for processing requests received from the terminals TEM1˜TEMn connected to the network and an SSD for storing data corresponding to the requests received from the terminals TEM1˜TEMn. In this regard, the SSD of FIG. 11 may be the storage system SSYS of FIG. 9. Therefore, the network system NSYS and the server system SV_SYS according to the present embodiment controls optimal data input/output of the SSD, thereby enhancing performance of the network system NSYS and the server system SV_SYS.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A storage device comprising:
a storage unit including a plurality of regions in which data is stored, the storage unit configured to input and output the data through channels corresponding to the plurality of regions;
an interface unit including a multi-entry queue, the multi-entry queue including a plurality of entries in which received commands are entered, the interface unit being configured to transmit data to be written in and read from the storage unit in response to the commands entered in the plurality of entries of the multi-entry queue; and
a firmware unit configured to allocate the plurality of entries of the multi-entry queue corresponding to the commands received by the interface unit.

2. The storage device of claim 1, wherein the multi-entry queue is configured such that different entries are set for each of the channels of the storage unit.

3. The storage device of claim 1, wherein the interface unit is configured to provide an interface for receiving the commands from the outside and transmitting responses to the commands to the outside, and the interface unit is configured to transmit the responses in a sequence in which the commands are processed by the storage device irrespective of a sequence in which the commands are received by the interface unit.

4. The storage device of claim 1, wherein the firmware unit is configured such that if one of the commands entered in the one of the plurality of entries of the multi-entry queue of the interface unit is processed, the firmware unit controls the interface unit to release the entry in which the processed command is entered.

5. The storage device of claim 1, wherein the firmware unit is configured such that if the interface unit receives the command to read the data stored in the storage unit, the firmware unit allocates the entry of the multi-entry queue corresponding to the command and then issues input/output of the storage unit.

6. The storage device of claim 1, further comprising:
a buffer unit for storing the data corresponding to the commands in the storage unit or for temporarily storing the data in order to read the data from the storage unit.

7. The storage device of claim 6, wherein the interface unit comprises:
a first interface unit including the multi-entry queue and configured to provide an interface with an external device;
a buffer management unit configured to control the buffer unit; and
a second interface unit configured to provide an interface with the storage unit.

8. The storage device of claim 1, wherein the storage unit is a flash memory.

9. The storage device of claim 1, wherein the storage unit is a solid state drive (SSD).

10. An input/output control method performed in a storage device, the method comprising:
receiving commands at an interface unit;
allocating a plurality of entries of a multi-entry queue of the interface unit based on the commands using a firmware unit;
entering the received commands in the allocated entries using the interface unit; and
transmitting data corresponding to the entered commands using the interface unit.

11. The method of claim 10, further comprising:
releasing, using the firmware unit, each entry of the multi-entry queue of the interface unit in which the entered command of the entry is completely processed.

12. The method of claim 10, further comprising:
allocating the entry of the multi-entry queue corresponding to the command using the firmware unit and then issuing input/output of the storage unit using the firmware unit, if the command to read the data stored in the storage unit is received by the interface unit.

13. The method of claim 10, wherein different entries in the multi-entry queue are set for each channel of the storage unit.

14. The method of claim 10, further comprising:
providing an interface for receiving the commands from the outside and transmitting responses to the commands to the outside, and transmitting the responses in a sequence in which the commands are processed by the storage device irrespective of a sequence in which the commands are received.

15. The method of claim 10, wherein the storage device is an SSD.

16. A storage device comprising:
a data storage unit including a plurality of logical pages arranged in a matrix, the matrix having a plurality of channels; and
an interface unit configured to receive commands for accessing the plurality of logical pages and to control access to the plurality of logical pages based on the received commands, the interface unit including a queue having a plurality of entries that correspond to the plurality of channels, respectively, each of the plurality of entries holding one or more commands from among the received commands, the one or more commands held by each entry being commands for the channel corresponding to the entry.

17. The storage device of claim 16, further comprising:
a firmware unit configured to allocate the plurality of entries of the multi-entry queue corresponding to the received commands.

18. The storage device of claim 17, wherein one or more of the received commands includes data, and the storage device further comprises:
a buffer unit configured to store data that is received from the storage unit before the data received from the storage unit is output externally, and to store the data included in one of the received commands before the data included in one of the received commands is stored in the storage unit.
